(19) United States
(12) Patent Application Publication
(10) Pub. No.: US 2009/0026094 A1
(43) Pub. Date: Jan. 29, 2009

(54) Two-pulse systems and methods for determining analyte concentration

(75) Inventors: David Deng, Weston, FL (US); Yongchao Zhang, Ellicott City, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Home Diagnostics, Inc.

(21) Appl. No.: 12/115,804

(22) Filed: May 6, 2008

Related U.S. Application Data
(60) Provisional application No. 60/917,386, filed on May 11, 2007.

(51) Int. Cl. G01N 27/26; G01N 27/403

(52) U.S. Cl. 205/792; 205/775; 204/400; 204/403.01

(57) ABSTRACT

Methods and systems for determining the concentration of a analyte in a physiological fluid are provided. The method includes applying at least one first pulse at a first potential and at least one second pulse at a second potential to a sample solution containing an analyte, wherein the first potential and the second potential can be the same polarity and the second potential can be larger than the first potential. The method also includes measuring at least one first current-transient associated with the at least one first pulse and at least one second current-transient associated with the at least one second pulse, determining a ratio between at least one said first current-transient and at least one said second current-transient, wherein said current-transients are measured at a substantially common sampling-time, and determining an analyte concentration of the sample solution based on the ratio of said current-transients.

This application claims the benefit of priority of U.S. Provisional Patent Application No. 60/917,386, filed on May 11, 2007, the disclosure of which is incorporated herein by reference.

### DESCRIPTION OF THE INVENTION

1. Field of the Invention

The present invention relates to the field of diagnostic testing systems for determining the concentration of an analyte in a solution and, more particularly, to systems and methods for measuring an analyte concentration using a two-pulse signal.

2. Background of the Invention

The present disclosure relates to a biosensor system for measuring an analyte in a bodily fluid, such as blood, wherein the system comprises a unique process and system for correcting inaccuracies in sample concentration measurements. For example, the present disclosure provides methods of correcting analyte concentration measurements of bodily fluids.

Electrochemical sensors have long been used to detect and/or measure the presence of substances in a fluid sample. In the most basic sense, electrochemical sensors comprise a reagent mixture containing at least an electron transfer agent (also referred to as an “electron mediator”) and an analyte specific bio-catalytic protein (e.g. a particular enzyme), and one or more electrodes. Such sensors rely on electron transfer between the electron mediator and the electrode surfaces and function by measuring electrochemical redox reactions. When used in an electrochemical biosensor system or device, the electron transfer reactions are transformed into an electrical signal that correlates to the concentration of the analyte being measured in the fluid sample.

The use of such electrochemical sensors to detect analytes in bodily fluids, such as blood or blood derived products, tears, urine, and saliva, has become important, and in some cases, vital to maintain the health of certain individuals. In the health care field, people such as diabetics, for example, have a need to monitor a particular constituent within their bodily fluids. A number of systems are available that allow people to test a body fluid, such as, blood, urine, or saliva, to conveniently monitor the level of a particular fluid constituent, such as, for example, cholesterol, proteins, and glucose. Patients suffering from diabetes, a disorder of the pancreas where insufficient insulin production prevents the proper digestion of sugar, have a need to carefully monitor their blood glucose levels on a daily basis. Routine testing and controlling blood glucose for people with diabetes can reduce their risk of serious damage to the eyes, nerves, and kidneys.

A number of systems permit people to conveniently monitor their blood glucose levels, and such systems typically include a test strip where the user applies a blood sample and a meter that “reads” the test strip to determine the glucose level in the blood sample. An exemplary electrochemical biosensor is described in U.S. Pat. No. 6,743,635 ('635 patent) which describes an electrochemical biosensor used to measure glucose level in a blood sample. The electrochemical biosensor system is comprised of a test strip and a meter. The test strip includes a sample chamber, a working electrode, a counter electrode, and fill-detect electrodes. A reagent layer is disposed in the sample chamber. The reagent layer contains an enzyme specific for glucose, such as, glucose oxidase, glucose dehydrogenase, and a mediator, such as, potassium ferricyanide or ruthenium hexaamine. When a user applies a blood sample to the sample chamber on the test strip, the reagents react with the glucose in the blood sample and the meter applies a voltage to the electrodes to cause redox reactions. The meter measures the resulting current that flows between the working and counter electrodes and calculates the glucose level based on the current measurements.

In some instances, electrochemical biosensors may be adversely affected by the presence of certain blood components that may undesirably affect the measurement and lead to inaccuracies in the detected signal. This inaccuracy may result in an inaccurate glucose reading, leaving the patient unaware of a potentially dangerous blood sugar level, for example. As one example, the particular blood hematocrit level (i.e. the percentage of the amount of blood that is occupied by red blood cells) can erroneously affect a resulting analyte concentration measurement. Another example can include various constituents affecting blood viscosity, cell lysis, concentration of charged species, pH, or other factors that may affect determination of an analyte concentration. For example, under certain conditions temperature could affect analyte readings and calculations.

Variations in a volume of red blood cells within blood can cause variations in glucose readings measured with disposable electrochemical test strips. Typically, a negative bias (i.e., lower calculated analyte concentration) is observed at high hematocrits, while a positive bias (i.e., higher calculated analyte concentration) is observed at low hematocrits. At high hematocrits, for example, the red blood cells may impede the reaction of enzymes and electrochemical mediators, reduce the rate of chemistry dissolution since there less plasma volume to solvate the chemical reactants, and slow diffusion of the mediator. These factors can result in a lower than expected glucose reading as less current is produced during the electrochemical process. Conversely, at low hematocrits, less red blood cells may affect the electrochemical reaction than expected, and a higher measured current can result. In addition, the blood sample resistance is also hematocrit dependent, which can affect voltage and/or current measurements.

Several strategies have been used to reduce or avoid hematocrit based variations on blood glucose. For example, test strips have been designed to incorporate meshes to remove red blood cells from the samples, or have included various compounds or formulations designed to increase the viscosity of red blood cell and attenuate the affect of low hematocrit on concentration determinations. Other test strips have included lysis agents and systems configured to determine hemoglobin concentration in an attempt to correct hematocrit. Further, biosensors have been configured to measure hematocrit by measuring optical variations after irradiating the blood sample with light, or measuring hematocrit based on a function of sample chamber fill time. These methods have the disadvantages of increasing the cost and complexity of test strips and may undesirably increase the time required to determine an accurate glucose measurement.

In addition, alternating current (AC) impedance methods have also been developed to measure electrochemical signals at frequencies independent of a hematocrit effect. Such methods suffer from the increased cost and complexity of advanced meters required for signal filtering and analysis.

Another prior hematocrit correction scheme is described in U.S. Pat. No. 6,475,372. In that method, a two potential pulse sequence is employed to estimate an initial glucose concentration and determine a multiplicative hematocrit correction factor. A hematocrit correction factor is a particular numerical value or equation that is used (such as, for example, by taking the product of the initial measurement and the determined hematocrit correction factor) to correct an initial concentration measurement. More specifically, a first pulse of one polarity is applied to the reaction cell with the sample, followed by a second pulse of an opposite polarity to the reaction cell with the sample.

The current responses resulting from both pulses are measured as a function of time, with pulse widths for the first step ranging from about 3 to 20 seconds, and for the second step from 1 to 10 s. The glucose concentration in the sample is then estimated from the measured current values. A blood hematocrit correction factor is determined using statistical methods, such as, from the mathematical fit of a three dimensional plot based on data collected at several glucose concentrations and blood hematocrit levels.

The three dimensional plot is created from the following variables: the ratio of the first average current value to the second average current value, the estimated glucose concentration, and the ratio of the YSI determined glucose concentration to the estimated glucose concentration minus a background value. The initial estimated glucose concentration is then multiplied by the calculated blood hematocrit correction factor to determine the reported glucose concentration.

Data processing using this technique, however, is slow as the first step greatly increases the overall test time of the biosensor, which is undesirable from the user's perspective. In addition, the method and system remain susceptible to temperature fluctuations and blood constituents that can affect the accuracy of any glucose concentration determination.

Accordingly, systems and methods for determining analyte concentration are desired that overcome the drawbacks of current biosensors and improve upon existing electrochemical biosensor technologies.

### SUMMARY OF THE INVENTION

One embodiment of the invention is directed to a method of determining an analyte concentration. The method includes applying at least one first pulse at a first potential and at least one second pulse at a second potential to a sample solution containing an analyte, wherein the first potential and the second potential are the same polarity and the second potential can be larger than the first potential. The method also includes measuring at least one first current-transient associated with the at least one first pulse and at least one second current-transient associated with the at least one second pulse, determining a ratio between at least one said first current-transient and at least one said second current-transient, wherein said current-transients are measured at a substantially common sampling-time, and determining an analyte concentration of the sample solution based on the ratio of said current-transients.

Another embodiment of the invention is directed to a method of determining a correction factor. The method includes applying at least one first pulse at a first potential and at least one second pulse at a second potential to a sample solution containing an analyte, wherein the first potential and the second potential can be the same polarity and the second potential can be larger than the first potential. The method also includes measuring at least one first current-transient associated with the at least one first pulse and at least one second current-transient associated with the at least one second pulse, and determining a first ratio of measured currents between at least one said first current-transient and at least one said second current-transient, wherein said current-transients are measured at a substantially common sampling-time. Further, the method includes determining a second ratio of calculated currents based on a steady-state current associated with the at least one second pulse, and determining a correction factor based on the first and second ratios.

Another embodiment of the invention is directed to an analyte testing system. The system includes a meter system configured to determine an analyte concentration of a sample solution, wherein the meter system is configured to apply at least one first pulse at a first potential and at least one second pulse at a second potential to a sample solution containing an analyte, wherein the first potential and the second potential are the same polarity and the second potential can be larger than the first potential. The meter system is also configured to measure at least one first current-transient associated with the at least one first pulse and at least one second current-transient associated with the at least one second pulse, determine a ratio between at least one said first current-transient and at least one said second current-transient, wherein said current-transients are measured at a substantially common sampling-time, and determine an analyte concentration of the sample solution based on the ratio of said current-transients.

Another embodiment of the invention is directed to an analyte testing system. The system includes a meter system configured to determine an analyte concentration of a sample solution, wherein the meter system is configured to apply at least one first pulse at a first potential and at least one second pulse at a second potential to a sample solution containing an analyte, wherein the first potential and the second potential are the same polarity and the second potential can be larger than the first potential. The meter system is also configured to measure at least one first current-transient associated with the at least one first pulse and at least one second current-transient associated with the at least one second pulse, and determine a first ratio of measured currents between at least one said first current-transient and at least one said second current-transient, wherein said current-transients are measured at a substantially common sampling-time. Further, the meter system can determine a second ratio of calculated currents based on a steady-state current associated with the at least one second pulse, determine a correction factor based on the first and second ratios, and determine the analyte concentration of the sample solution based on the correction factor and current reading.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A illustrates test media associated with an exemplary meter system, according to an exemplary embodiment of the present disclosure.

FIG. 1B illustrates a test meter that can be used with test media, according to an exemplary embodiment of the present disclosure.

FIG. 1C illustrates another test meter that can be used with test media, according to an exemplary embodiment of the present disclosure.

FIG. 2A is a top plan view of a test strip, according to an exemplary embodiment of the present disclosure.

FIG. 2B is a cross-sectional view of the test strip of FIG. 2A, taken along line 2B-2B.

FIG. 3 depicts a two-pulse waveform, according to an exemplary embodiment of the present disclosure.

FIG. 4 depicts theoretical concentration profiles formed in response to a two-pulse waveform, according to an exemplary embodiment of the present disclosure.

FIG. 5 is a graph depicting the relationship between a ratio of current-transients and glucose levels, according to an exemplary embodiment of the present disclosure.

FIG. 6 is a graph depicting the relationship between a ratio of current-transients and time, according to an exemplary embodiment of the present disclosure.

FIG. 7 is a graph depicting the relationship between a ratio of current-transients and glucose levels, according to another exemplary embodiment of the present disclosure.

FIG. 8 is a graph depicting the relationship between a ratio of current-transients and steady-state current, according to an exemplary embodiment of the present disclosure.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

In accordance with an exemplary embodiment, a method of determining an analyte concentration is described. Many industries have a commercial need to monitor the concentration of particular analytes in various fluids. The oil refining industry, wineries, and the dairy industry are examples of industries where fluid testing is routine. In the health care field, people such as diabetics, for example, need to routinely monitor analyte levels of their bodily fluids using biosensors. A number of systems are available that allow people to test a physiological fluid (e.g. blood, urine, or saliva), to conveniently monitor the level of a particular analyte present in the fluid, such as, for example, glucose, cholesterol, ketone bodies, or specific proteins. Such systems can include a meter configured to determine the analyte concentration and/or display representative information to a user. In addition, such metering systems can incorporate disposable test strips configured for single-use testing of a fluid sample.

While such metering systems have been widely adopted, some are susceptible to inaccurate readings resulting from analyzing fluids of differing properties. For example, blood glucose monitoring using electrochemical techniques can be highly dependent upon hematocrit and/or temperature fluctuations. The present method reduces unwanted influences by applying a small potential excitation for a short period to the sample before applying a full potential excitation for an extended time period as occurs with traditional electrochemical systems. The ratio of current-transients measured shortly after the excitation pulses has been found to be generally independent of hematocrit and/or temperature fluctuations. Also, the ratio shows a generally linear relationship with analyte concentration, permitting an improved determination of analyte concentration. The present disclosure provides methods and systems for improved determination of analyte concentration.

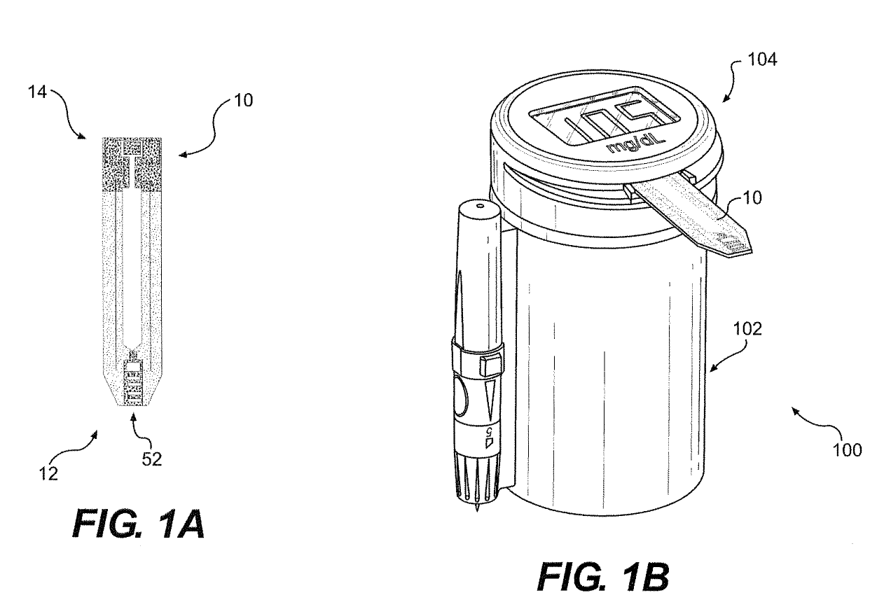

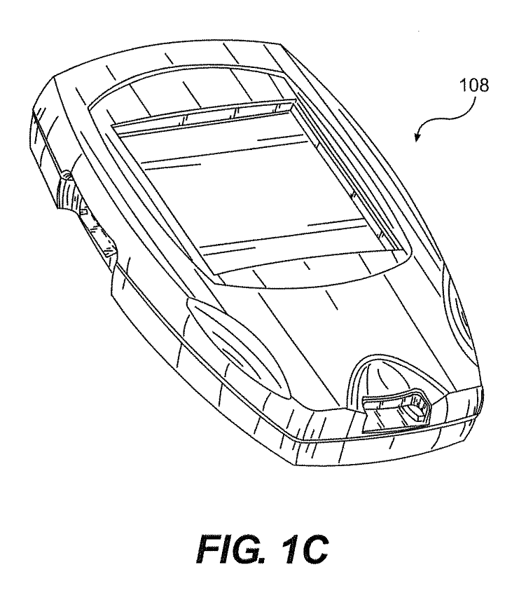

FIG. 1A illustrates a diagnostic test strip 10, according to an exemplary embodiment of the present disclosure. Test strip 10 of the present disclosure may be used with a suitable test meter 100, 108, as shown in FIGS. 1B and 1C, configured to detect, and/or measure the concentration of one or more analytes present in a sample solution applied to test strip 10. As shown in FIG. 1A, test strip 10 is generally planar and elongated in design. However, test strip 10 may be provided in any suitable form including, for example, ribbons, tubes, tabs, discs, or any other suitable form. Furthermore, test strip 10 can be configured for use with a variety of suitable testing modalities, including electrochemical tests, photochemical tests, electro-chemiluminescent tests, and/or any other suitable testing modality.

Test strip 10 can be in the form of a generally flat strip that extends from a proximal end 12 to a distal end 14. For purposes of this disclosure, “distal” refers to the portion of test strip 10 further from the fluid source (i.e. closer to the meter) during normal use, and “proximal” refers to the portion closer to the fluid source (e.g. a finger tip with a drop of blood for a glucose test strip) during normal use. In some embodiments, proximal end 12 of test strip 10 may include a sample chamber 52 configured to receive a fluid sample, such as, for example, a blood sample. Sample chamber 52 and test strip 10 of the present specification can be formed using materials and methods described in commonly owned U.S. Pat. No. 6,743,635, which is hereby incorporated by reference in its entirety.

Test strip 10 can be any convenient size. For example, test strip 10 can measure approximately 35 mm long (i.e., from proximal end 12 to distal end 14) and approximately 9 mm wide. Proximal end 12 can be narrower than distal end 14 in order to assist the user in locating the opening where the blood sample is to be applied. Further, test meter 100, 108 can be configured to operate with, and dimensioned to receive, test strip 10.

Test meter 100, 108 may be selected from a variety of suitable test meter types. For example, as shown in FIG. 1B, test meter 100 includes a vial 102 configured to store one or more test strips 10. The operative components of test meter 100 may be contained in a meter cap 104. Meter cap 104 may contain electrical meter components, can be packaged with test meter 100, and can be configured to close and/or seal vial 102. Alternatively, test meter 108 can include a monitor unit separated from storage vial, as shown in FIG. 1C. In some embodiments, meter 100 can include one or more circuits, processors, or other electrical components configured to perform one or more steps of the disclosed method of determining an analyte concentration. Any suitable test meter may be selected to provide a diagnostic test using test strip 10 produced according to the disclosed methods.

### Test Strip Configuration

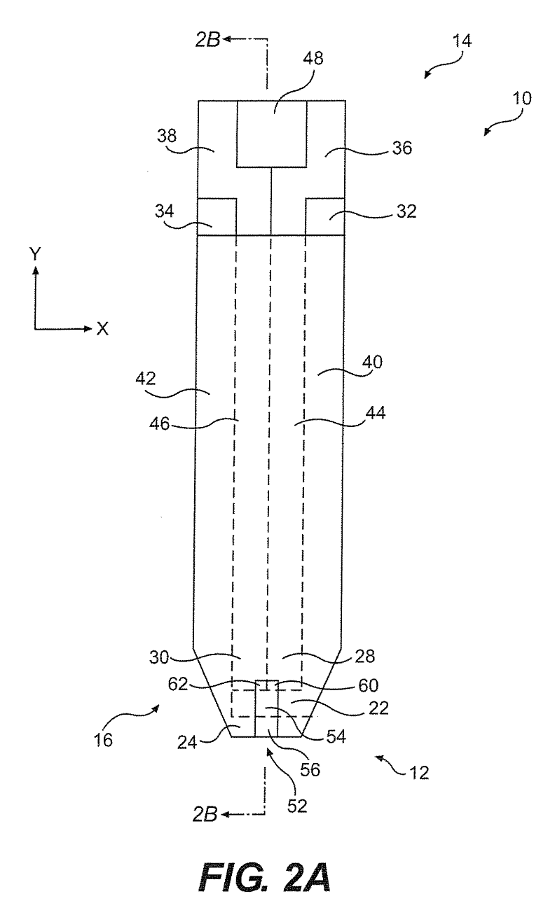

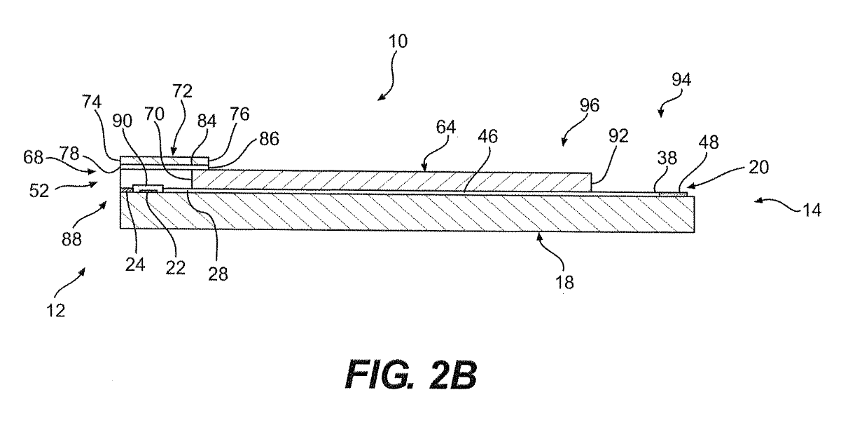

FIGS. 2A and 2B show a test strip 10, in accordance with an exemplary embodiment of the present disclosure. As shown in FIG. 2B, test strip 10 can include a generally layered construction. Working upwardly from the bottom layer, test strip 10 can include a base layer 18 extending along the entire length of test strip 10. Base layer 18 can be formed from an electrically insulating material that has a thickness sufficient to provide structural support to test strip 10. For example, base layer 18 can be a polyester material about 0.35 mm thick.

According to the illustrative embodiment, a conductive layer 20 is disposed on base layer 18. Conductive layer 20 includes a plurality of electrodes disposed on base layer 18 near proximal end 12, a plurality of electrical contacts disposed on base layer 18 near distal end 14, and a plurality of conductive regions electrically connecting the electrodes to the electrical contacts. In the illustrative embodiment depicted in FIG. 2A, the plurality of electrodes includes a working electrode 22, a counter electrode 24, and a pair of fill-detect electrodes 28, 30. As described in detail below, the term “working electrode” refers to an electrode at which an electrochemical oxidation and/or reduction reaction occurs, e.g., where an analyte, typically the electron mediator, is oxidized or reduced. “Counter electrode” refers to an electrode paired with working electrode 22.

The electrical contacts at distal end 14 can correspondingly include a working electrode contact 32, a proximal electrode contact 34, and fill-detect electrode contacts 36, 38. The conductive regions can include a working electrode conductive region 40, electrically connecting working electrode 22 to working electrode contact 32, a counter electrode conductive region 42, electrically connecting counter electrode 24 to counter electrode contact 36, and fill-detect electrode conductive regions 44, 46 electrically connecting fill-detect electrodes 28, 30 to fill-detect contacts 36, 38. Further, the illustrative embodiment is depicted with conductive layer 20 including an auto-on conductor 48 disposed on base layer 18 near distal end 14.

In addition to auto-on conductor 48, the present disclosure provides test strip 10 that includes electrical contacts near distal end 14 that are resistant to scratching or abrasion. Such test strips can include conductive electrical contacts formed of two or more layers of conductive and/or semi-conductive material. Further, information relating to electrical contacts that are resistant to scratching or abrasion are described in co-owned U.S. patent application Ser. No. 11/458,298 which is incorporated by reference herein in its entirety.

The next layer of test strip 10 can be a dielectric spacer layer 64 disposed on conductive layer 20. Dielectric spacer layer 64 is composed of an electrically insulating material, such as polyester. Dielectric spacer layer 64 can be about 0.100 mm thick and covers portions of working electrode 22, counter electrode 24, fill-detect electrodes 28, 30, and conductive regions 40-46, but in the illustrative embodiment does not cover electrical contacts 32-38 or auto-on conductor 48. For example, dielectric spacer layer 64 can cover substantially all of conductive layer 20 thereon, from a line just proximal of contacts 32 and 34 all the way to proximal end 12, except for sample chamber 52 extending from proximal end 12. In this way, sample chamber 52 can define an exposed portion 54 of working electrode 22, an exposed portion 56 of counter electrode 24, and exposed portions 60, 62 of fill-detect electrodes 28, 30.

In some embodiments, sample chamber 52 can include a first opening 68 at proximal end 12 of test strip 10, and a second opening 86 for venting sample chamber 52. Further, sample chamber 52 may be dimensioned and/or configured to permit, by capillary action, a blood sample to enter through first opening 68 and remain within sample chamber 52. For example, sample chamber 52 can be dimensioned to receive about 1 micro-liter or less. For example, first sample chamber 52 can have a length (i.e., from proximal end 12 to distal end 70) of about 0.140 inches, a width of about 0.060 inches, and a height (which can be substantially defined by the thickness of dielectric spacer layer 64) of about 0.005 inches. Other dimensions could be used, however.

A cover 72, having a proximal end 74 and a distal end 76, can be attached to dielectric spacer layer 64 via an adhesive layer 78. Cover 72 can be composed of an electrically insulating material, such as polyester, and can have a thickness of about 0.1 mm. Additionally, the cover 72 can be transparent. Adhesive layer 78 can include a polyacrylic or other adhesive and have a thickness of about 0.013 mm. A break 84 in adhesive layer 78 can extend from distal end 70 of first sample chamber 52 to an opening 86, wherein opening 86 is configured to vent sample chamber 52 to permit a fluid sample to flow into sample chamber 52. Alternatively, cover 72 can include a hole (not shown) configured to vent sample chamber 52. It is also contemplated that various materials, surface coatings (e.g. hydrophilic and/or hydrophobic), or other structure protrusions and/or indentations at proximal end 12 may be used to form a suitable sample reservoir.

As shown in FIG. 2B, a reagent layer 90 is disposed in sample chamber 52. In some embodiments, reagent layer 90 can include one or more chemical constituents to enable the level of glucose in the blood sample to be determined electrochemically. Reagent layer 90 may include an enzyme specific for glucose, such as glucose oxidase or glucose dehydrogenase, and a mediator, such as potassium ferricyanide or ruthenium hexamine. In other embodiments, other reagents and/or other mediators can be used to facilitate detection of glucose and other analytes contained in blood or other physiological fluids. In addition, reagent layer 90 may include other components, buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485). For example, an exemplary formulation contains 50-250 mM potassium phosphate at pH 6.75-7.50, 150-190 mM ruthenium hexamine, 3500-5000 U/mL PQQ-dependent glucose dehydrogenase, 0.5-2.0% polyethylene oxide, 0.025-0.20% NATROSOL 250M (hydroxyethylcellulose), 0.675-2.5% Avicel (microcrystalline cellulose), 0.05-0.25% TRITON-X (surfactant) and 2.5-5.0% trehalose.

In some embodiments, various constituents may be added to reagent layer 90 to at least partially reduce unwanted bias of an analyte measurement. For example, various polymers, molecules, and/or compounds may be added to reagent layer 90 to reduce cell migration and hence may increase the accuracy of a measurement based on an electrochemical reaction. Also, one or more conductive components may be coated with a surface layer (not shown) to at least partially restrict cell migration onto the one or more conductive components. These and other techniques known in the art may be used to reduce unwanted signal bias.

Although FIGS. 2A and 2B illustrate an illustrative embodiment of test strip 10, other configurations, chemical compositions and electrode arrangements could be used. For example, fill-detect electrode 30 can function with working electrode 22 to perform a fill-detect feature, as previously described. Other configurations of electrodes on test strip 10 are possible, such as, for example, a single fill-detect electrode, multiple fill-detect electrodes aligned in the y-axis (as opposed to the x-axis as shown in FIG. 2A), and/or multiple working electrodes.

In some embodiments, working electrode 22 and counter electrode 24 can be spaced further apart. For example, this electrode pair may be spaced at a distance of 500 μm to 1000 μm such that a two-pulse measurement obtained from the electrode pair can be optimized for correction of the influence of hematocrit, temperature, or other factors.

### Test Strip and Meter Operation

As previously described, test strip 10 can be configured for placement within meter 100, or similar device, configured to determine the concentration of an analyte contained in a solution in contact with test strip 10. Meter 100 can include electrical components, circuitry, and/or processors configured to perform various operations to determine analyte concentration based on electrochemical techniques. For example, the metering system, such as meter 100 and associated test strip 10, may be configured to determine the glucose concentration of a blood sample. In some embodiments, systems and methods of the present disclosure permit determination of blood glucose levels generally unaffected by blood constituents, hematocrit levels, and temperature.

In operation, the battery-powered meter 100 may stay in a low-power sleep mode when not in use. When test strip 10 is inserted into meter 100, one or more electrical contacts at distal end 14 of test strip 10 could form electrical connections with one or more corresponding electrical contacts in meter 100. These electrical contacts may bridge electrical contacts in meter 100, causing a current to flow through a portion of the electrical contacts. Such a current flow can cause meter 100 to “wake-up” and enter an active mode.

Meter 100 can read encoded information provided by the electrical contacts at distal end 14. Specifically, the electrical contacts can be configured to store information, as described in U.S. patent application Ser. No. 11/458,298. In particular, an individual test strip 10 can include an embedded code containing data associated with a lot of test strips, or data particular to that individual strip. The embedded information can represent data readable by meter 100. For example, a microprocessor associated with meter 100 could access and utilize a specific set of stored calibration data specific to an individual test strip 10 and/or a manufactured lot test strips 10. Individual test strips 10 may be calibrated using standard solutions, and associated calibration data could be applied to test strips 10 of the same or similar lots of manufactured test strips 10.

In some embodiments, “lot specific” calibration information can be encoded on a code chip accompanying a vial of strips, or coded directly onto one or more test strips 10 manufactured in a common lot of test strips. Lot calibration can include any suitable process for calibrating test strip 10 and/or meter 100. For example, calibration can include applying at the factory a standard solution to one or more test strips 10 from a manufacturing lot, wherein the standard solution can be a solution of known glucose concentration, hematocrit, temperature, or any other appropriate parameter associated with the solution. Following application of the standard solution, one or more pulses can be applied to test strip 10, as described below. Calibration data may then be determined by correlating various measurements to be determined by the meter 100 during use by the patient with one or more parameters associated with the standard solution. For example, a measured current may be correlated with a glucose concentration, or a voltage correlated with hematocrit. Such calibration data, that can vary from lot to lot with the performance of the test strips, may then be stored on test strip 10 and/or meter 100, and used to determine analyte concentration of an analyte sample, as described below.

Test strip 10 can be tested at any suitable stage during a manufacturing process. Also, a test card (not shown) could be tested during any suitable stage of a manufacturing process, as described in co-owned U.S. patent application Ser. No. 11/504,710 which is incorporated by reference herein in its entirety. Such testing of test strip 10 and/or the test card can permit determination and/or encoding of calibration data at any suitable stage during a manufacturing process. For example, calibration data associated with methods of the present disclosure can be encoded during the manufacturing process.

In operation meter 100 can be configured to identify a particular test to be performed or provide a confirmation of proper operating status. Also, calibration data pertaining to the strip lot, for either the analyte test or other suitable test, could be otherwise encoded or represented, as described above. For example, meter 100 can identify the inserted strip as either test strip 10 or a check strip (not shown) based on the particular code information.

If meter 100 detects test strip 10, it may perform a test strip sequence. The test strip sequence may confirm proper functioning of one or more components of test strip 10. For example, meter 100 could validate the function of working electrode 22, counter electrode 24, and, if included, the fill-detect electrodes, by confirming that there are no low-impedance paths between any of these electrodes. If the electrodes are valid, meter 100 could provide an indication to the user that a sample may be applied to test strip 10.

If meter 100 detects a check strip, it may perform a check strip sequence. The system may also include a check strip configured to confirm that the instrument is electrically calibrated and functioning properly. The user may insert the check strip into meter 100. Meter 100 may then receive a signal from the check strip to determine if meter 100 is operating within an acceptable range.

In other embodiments, test strip 10 and/or meter 100 may be configured to perform a calibration process based on a standard solution, also termed a control solution. The control solution may be used to periodically test one or more functions of meter 100. For example, a control solution may include a solution of known electrical properties, and an electrical measurement of the solution may be performed by meter 100. Upon detecting the presence of a control solution, meter 100 can perform an operational check of test strip 10 functionality to verify measurement integrity. For example, the read-out of meter 100 may be compared to a known glucose value of the solution to confirm that meter 100 is functioning to an appropriate accuracy. In addition, any data associated with a measurement of a control solution may be processed, stored and/or displayed using meter 100 differently to any data associated with a glucose measurement. Such different treatment of data associated with the control solution may permit meter 100, or user, to distinguish a glucose measurement, or may permit exclusion of any control measurements when conducting any mathematical analysis of glucose measurements.

### Analyte Concentration Determination

Meter 100 can apply a signal to test strip 10 to determine a concentration of an analyte contained in a solution contacting test strip 10. In some embodiments, the signal can be applied following a determination that sample chamber 52 of test strip 10 contains a sufficient quantity of fluid sample. To determine the presence of sufficient fluid, meter 100 can apply a detect voltage between any suitably configured electrodes, such as, for example, fill-detect electrodes. The detect voltage can detect the presence of sufficient quantity of fluid (e.g. blood) within sample chamber 52 by detecting a current flow between the fill-detect electrodes. In addition, to determine that the fluid sample has traversed reagent layer 90 and mixed with the chemical constituents in reagent layer 90, meter 100 may apply a fill-detect voltage to the one or more fill-detect electrodes and measure any resulting current. If the resulting current reaches a sufficient level within a predetermined period of time, meter 100 can indicate to a user that adequate sample is present. In some embodiments, meter 100 can be programmed to wait for a predetermined period of time after initially detecting the blood sample to allow the blood sample to react with reagent layer 90. Alternatively, meter 100 may be configured to immediately begin taking readings in sequence.

Meter 100 can be configured to apply various signals to test strip 10. For example, an exemplary fluid measurement sequence could include amperometry, wherein meter 100 can apply an assay voltage between working and counter electrodes 22, 24 of test strip 10. In some embodiments, the assay voltage could near the redox potential of constituents of reagent layer 90. Following, meter 100 could sample one or more measurements of the resulting current flowing between working and counter electrodes 22, 24. The resulting current can be mathematically related to the analyte concentration to be measured, such as, for example, glucose concentration in a blood sample. Voltammetry and coulometry approaches, as known in the art, could also be used with a suitable configured meter 100 and test strip 10.

In some embodiments, one or more constituents of reagent layer 90 may react with blood glucose such that glucose concentration may be determined using electrochemical techniques. For example, suitable enzymes of reagent layer 90 (e.g. glucose oxidase or glucose dehydrogenase) could react with blood glucose. Glucose could be oxidized to form gluconic acid, which may in turn reduce a suitable mediator, such as, for example, ferricyanide or ruthenium hexamine. Voltage applied to working electrode 22 may oxidize the ferrocyanide to form ferricyanide, and generating a current proportional to the glucose concentration of the blood sample.

As mentioned previously, biosensors may inaccurately measure a particular analyte level in a fluid sample due to unwanted affects of various blood components. For example, the hematocrit level (i.e. the percentage of blood occupied by red blood cells) of blood can erroneously affect a measurement of analyte concentration. Thus, it may be desirable to apply a signal and/or signal processing techniques to reduce the sensitivity of the determination of analyte concentration to hematocrit and other factors that may adversely affect concentration determination.

In some embodiments, a signal at two distinct potentials can be applied to a fluid sample in contact with test strip 10. Meter 100 may then measure two current values associated with the signal, wherein the ratio of the two current values can be proportional to the analyte concentration of the fluid sample. This method may reduce error associated with determination of analyte concentration based on electrochemical techniques. For example, the influence of hematocrit, temperature, blood constituents, and other factors that may adversely affect determination of blood glucose levels may be reduced. Therefore, the precision and/or accuracy of blood glucose levels may be improved using the method and/or systems of the present disclosure.

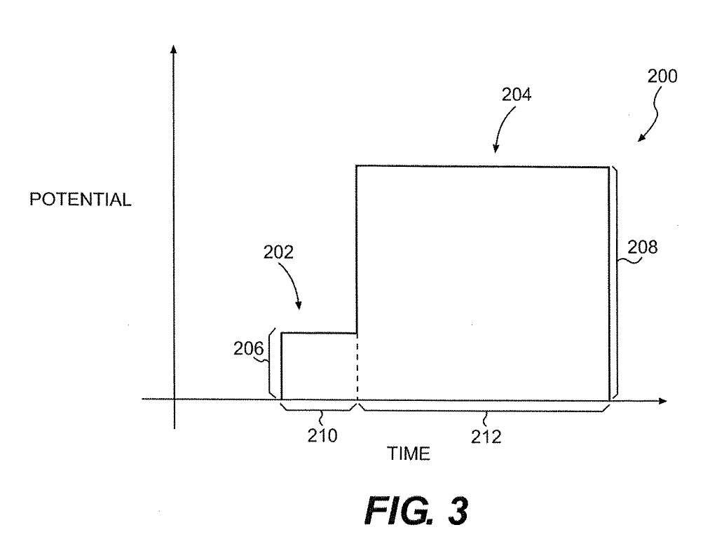

FIG. 3 depicts a two-pulse signal 200, according to an exemplary embodiment of the present disclosure. For example, two-pulse signal 200 can be applied to a fluid sample contained within test strip 10. Meter 100 can be configured to measure two current values resulting from application of two-pulse signal 200 across working electrode 22 and counter electrode 24. In some embodiments, meter 100 may determine a blood glucose level based on a ratio of two current-transients, as described below. Optionally, a glucose calculation could be based on a steady-state current value and modified using a correction factor determined from the current-transient ratio, as described below. Either technique, along with various calibration data contained within test strip 10 and/or meter 100, may permit a more accurate determination of glucose concentration than similar techniques known in the art.

The systems and methods of the present disclosure use electrochemical techniques to measure redox reactions by electron transfer between an electron mediator and an electrode surface. As noted above, these electron transfer reactions (such as the ferrocyanide or ruthenium hexaamine reactions described above) can provide an output signal proportional to the concentration of an analyte of interest. More particularly, the output signal results from the application of a signal input at working electrode 22 relative to counter electrode 24. In some embodiments, the signal can include two-pulse signal 200, wherein two-pulse signal 200 includes at least two distinct pulses.

In some embodiments, two-pulse signal 200 can be a waveform including a first pulse 202 and a second pulse 204. First pulse 202 can include a first potential 206 and second pulse 204 can include a second potential 208, wherein first potential 206 and second potential 208 are the same polarity. Specifically, first and second potential 206, 208 can be applied across working electrode 22 and counter electrode 24 such that both first and second potential 206, 208 are positive polarity or both first and second potential 206, 208 are negative polarity.

First potential 206 and second potential 208 may be constant magnitudes, as shown in FIG. 3. It is also contemplated that first potential 206 and/or second potential 208 may include variable magnitudes, such as, for example, one or more pulse-trains of constant or different magnitudes. In some embodiments, first potential 206 can be in a range of about 0.005 volts to about 0.5 volts and second potential 208 can be in a range of about 0.03 volts to about 3.00 volts. For example, first potential 206 can be about 0.05 volts and second potential 208 can be about 0.30 volts. Further, first potential 206 and/or second potential 208 may include real and/or imaginary components, phase angles, or other suitable designations.

An optimal voltage range for both the first and second excitation pulses can be applied to the mediator used in previously described examples. If different mediators are used, optimal voltage values of the two pulses will be related to the oxidation and reduction potentials of the specific mediator used in the biosensor formulation. With regard to exemplary potential magnitudes, for ruthenium hexamine, first potential 206 can be about 0.05 volts and second potential 208 can be about 0.3 V. Ruthenium hexamine has a relatively low excitation potential, while other mediators have higher excitation potentials, such as, for example, potassium ferricyanide. In some situations, mediators with higher excitation values may be more effective than lower excitation mediators because the difference between optimal voltages for the first and second excitation pulses can be larger. Consequently, the measured current ratios can have a higher slope versus analyte concentration, which results in more accurate correction factors. Therefore, high excitation mediators may prove more effective than low excitation mediators under certain conditions.

First pulse 202 can include a first time-period 210 and second pulse 204 can include a second time-period 212. In some embodiments, first time-period 210 and second time-period 212 are not the same. For example, first time-period 210 can be in a range of about 0.02 seconds to about 2 seconds, and second time-period 212 can be in a range of about 0.5 seconds to about 10 seconds. Specifically, first time-period 210 can be about 0.2 seconds, and second time-period 212 can be about 4 seconds, such as, for example, 3.8 seconds.

In some embodiments, two-pulse signal 200 can include first pulse 202 and second pulse 204 wherein first pulse 202 and second pulse 204 are separated by a delay time (not shown). For example, first time-period 210 and second time-period 212 may be separated by a delay time such that following first pulse 202, two-pulse signal 200 can includes a period of time wherein the potential of two-pulse signal 200 is about zero volts, or similar small voltage. Two-pulse signal 200 can include one or more delay times wherein the magnitude of two-pulse signal 200 can be about zero before second pulse 204. In addition, second pulse 204 can be applied before first pulse 202, or first pulse 202 could be applied during second pulse 204.

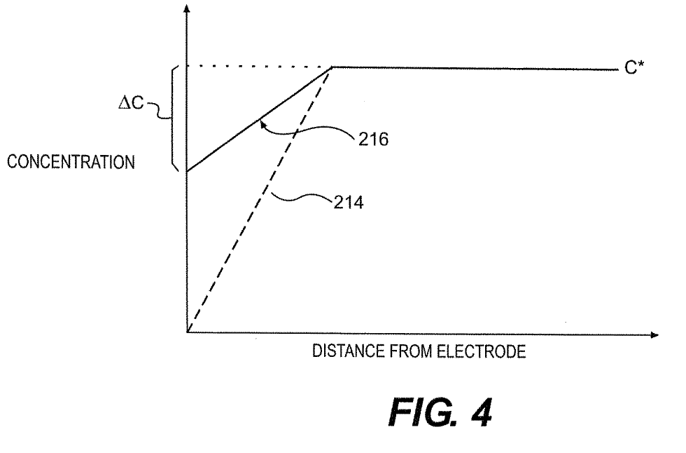

FIG. 4 depicts two theoretical concentration gradients as a function of distance from an electrode surface, wherein the gradients result from the application of two-pulse signal 200 to the sample solution. While this disclosure is not intended to be bound by theory, a brief discussion of theoretical considerations underlying the two-pulse technique is provided by way of explanation.

Determination of glucose, or other analyte, concentration can be based on the faradaic current generated by a potential applied across a pair of electrodes. In response to an applied potential, a current can flow between the pair of electrodes due to a redox reaction. Specifically, a positive pulse can cause oxidation of a mediator reduced as part of an enzyme-glucose reaction. Alternatively, a negative pulse can cause reduction of the mediator. Either positive or negative pulse potential may be used in the present disclosure.

Immediately following application of a potential across an electrode pair, current flow can be generally described by a diffusion limited (faradaic) current. Other current contributions may be present, but by the time any current measurement is sampled, other current contribution have decayed to such a degree that the faradaic contribution predominates. The faradaic current can be generally described by the Cottrell equation, Equation No. 1:

$$i ( t ) = \frac{{nFAD}^{\frac{1}{2}}}{{π}^{\frac{1}{2}} {t}^{\frac{1}{2}}} C *$$

where n is the number of transferred electrons, F is Faraday's constant, A is the electrode area, D is the diffusion coefficient, t is time, and C* is the initial analyte concentration. Equation No. 1 essentially describes the time dependent behavior of a current-transient, or current value at a specific time following potential excitation.

As previously described, the concentration of a charged constituent can be considered proportional to the concentration of the analyte to be determined. In some embodiments, second pulse 204 can be applied at potential 208 such that the concentration of the charged constituent can be depleted. Application of such a pulse results in an approximately linear concentration gradient at discrete time points following potential excitation. This concentration gradient is indicated by a gradient 214, wherein gradient 214 is about zero at the surface of an electrode, and rises approximately linearly to C* at some distance from the electrode surface. Such a gradient is time dependent (over the sampling times of interest), wherein the longer the excitation time, the lower the gradient as the concentration becomes more depleted further away from the electrode surface. Traditional redox methods commonly use such long-term steady-state current measurements to determine glucose concentration, given the proportionality between current and initial analyte concentration as indicated by Equation No. 1. However, determining the other variables of Equation No. 1 can be problematic.

As described above, first pulse 202 can be of lesser potential and/or duration than second pulse 204. As such, the concentration gradient formed in response to first pulse 202 can be different to the gradient formed by second pulse 204. In particular, first pulse 202 may not be of sufficient magnitude and/or duration to permit a redox reaction to proceed, or almost proceed, to completion on the electrode surface. Such an incomplete redox reaction will not cause complete, or almost complete, depletion of the charged constituent proportionally related to the analyte whose concentration is to be determined. In particular, such an incomplete reaction results in a gradient 216, wherein gradient 216 is not zero at the surface of the electrode, in contrast to gradient 214. Rather, the rise of gradient 216 can be represented by ΔC=(C*−C₍ₓ₌₀₎), wherein C₍ₓ₌₀₎ is the concentration of charged constituent associated with the incomplete redox reaction at the electrode surface.

Mathematically, first pulse 202 can be described by the following equation, Equation No. 2:

$$i ( t ) = \frac{{nFAD}^{\frac{1}{2}}}{{π}^{\frac{1}{2}} {t}^{\frac{1}{2}}} [ C * - {C}_{( x = 0 )} ]$$

Therefore, first pulse 202 results in a current response primarily described by Equation No. 2, while second pulse 204 results in a current response primarily described by Equation No. 1. Determining the ratio between the second and first current, at time t, provides a relationship as described by Equation No. 3:

$$\frac{{i}_{2}}{{i}_{1}} ( t ) = \frac{C *}{Δ C}$$

where ΔC=(C*−C₍ₓ₌₀₎). ΔC is generally less than C*, and is a function of first potential 206. Specifically, ΔC is dependent upon first potential 206 such that an increase in first potential 206 results in a decrease in ΔC.

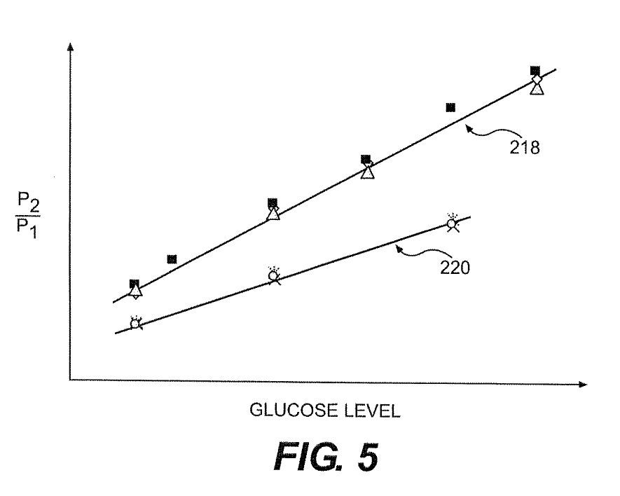

FIG. 5 is a graph depicting the relationship between a ratio of current-transients and glucose levels, according to an exemplary embodiment of the present disclosure. The current-transient are measured at a common sampling time following initiation of first pulse 202 and second pulse 204 (i.e. potential excitation), as described in detail below. As shown in, P₂ refers to a current-transient associated with second pulse 204 and P₁ refers to a current-transient associated with first pulse 202.

FIG. 5 shows a ratio of first and second current-transients sampled at 0.05 seconds post-excitation. A line 218 represents a line of best fit through various current-transient data obtained with first potential 206 of 0.03 volts and from various blood samples containing hematocrits ranging from about 25% to about 55%. As shown by line 218, there is relatively little deviation from linear line 218 over a range of glucose levels and hematocrit values. Such data indicates that the ratio of current-transients obtained using Equation 3 is generally independent of the hematocrit level of each sample, as expected by the discussion outlined above.

Another set of data falls on another line of best fit represented by a line 220. Specifically, line 220 represents a line of best fit through data obtained with first potential 206 of 0.05 volts. In accordance with Equation No. 3, the slope of line 220 is less than the slope of line 218 as the larger potential associated with line 220 (e.g. 0.05 volts) in comparison to line 218 (e.g. 0.03 volts) increases the magnitude of the denominator. Therefore, in order to maximize the range of possible current-transient ratios, a lower first potential 206 may be preferable to a higher first potential 206.

To provide calibration data, the first and second current-transients can be measured using multiple standard fluid samples. These initial measurements may be performed using a particular lot of test strips. Standard samples, having known glucose concentration levels, can be tested to determine and record the associated current-transient values for different glucose concentration values. These known glucose concentration levels of the samples are then correlated with particular variables based on current data. Calibration data can include any suitable information, and or storage method, such as, for example, an equation, an algorithm, a look-up chart, or any other suitable method.

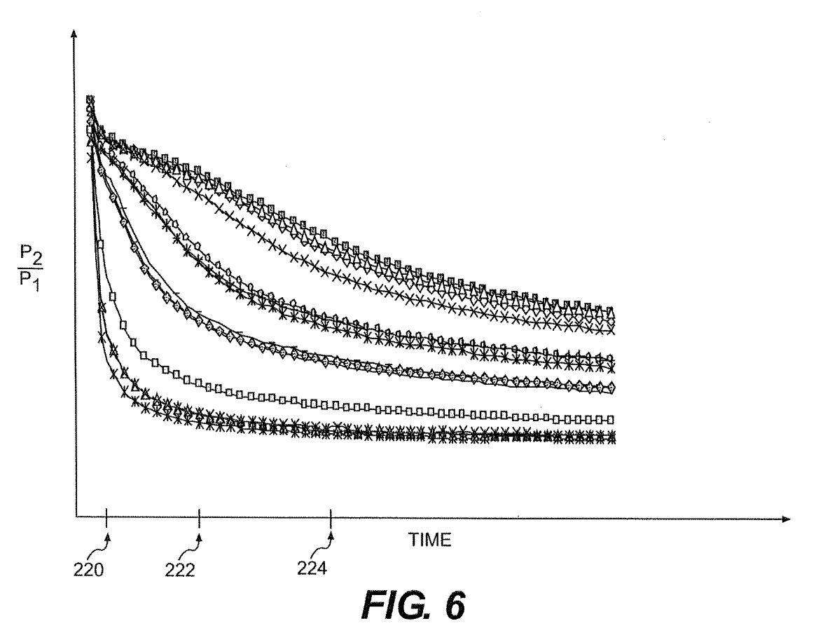

As previously described, the current-transients associated with first pulse 202 and second pulse 204 may be measured at a common sampling time following initiation of each pulse. FIG. 6 is a graph depicting the relationship between current-transient ratios and time, according to an exemplary embodiment of the present disclosure. Specifically, the various data represent different time sampling of different solutions containing various glucose concentrations and hematocrit levels. These data indicate that the sampling time of a current-transient can affect the maximum possible range of current-transient ratios. For example, at a sampling time 220 the various current-transient ratios are difficult to discern. Specifically, ratios from different samples exhibit considerable overlap and discerning one sample from another would likely prove difficult. In contrast, at a sampling time 222 the distribution of ratios from different samples is more dispersed, and so more readily discernable than to at sampling time 220. However, an optimal sampling window exists as gradually the ratios converge. Specifically, time sampling following a sample time 224 shows increased convergence, and hence less range of current-transient ratios. Therefore, to optimize a possible range of current-transient ratios, time sample should occur between about sampling time 222 and sampling time 224. In some embodiments, sampling times can be in the range of about 0.001 seconds to about 1 second. Specifically, sampling times can be in the range of about 0.02 seconds to about 0.10 seconds.

The ratio of current-transients can be optimized based on several factors previously outlined. In particular, choice of mediator, enzyme, pulse potentials, and/or sampling time can all be optimized based on meter 100, test strip 10, physiological fluid, and/or analyte of interest. For example, it may prove more beneficial to use first potential 206 of 0.03 volts or 0.05 volts. In addition, sampling at 0.02 seconds or 0.1 seconds post-excitation may be optimal. In some embodiments, a plurality of sampling times may be used to provide a range of current-transient ratios, similar to shown in FIG. 6. Such additional sampling may permit more accurate concentration determinations and/or a greater range of concentration determinations. These and other optimization techniques are contemplated by the present disclosure.

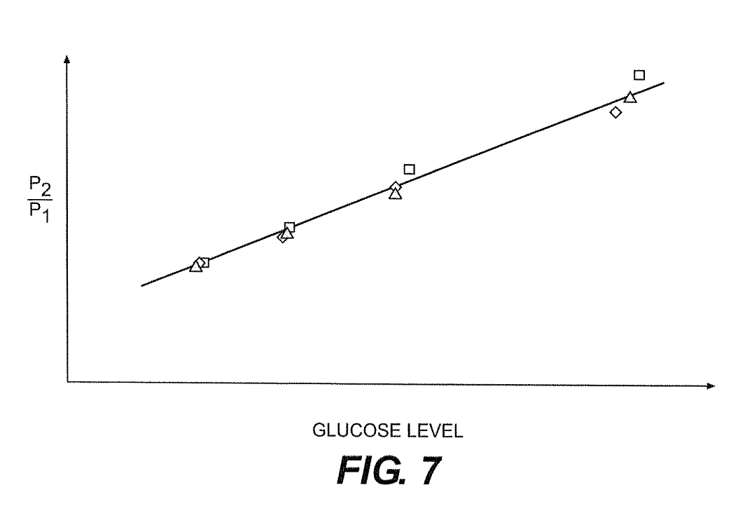

FIG. 7 is a graph depicting the relationship between a ratio of current-transients and glucose levels at different temperatures. Traditional blood-glucose measurement techniques can be highly susceptible to temperature affects. For example, a difference of 30° C. can more than double the measured glucose level (data not shown). FIG. 7 depicts an almost linear relationship between current-transient ratios and various blood samples measured at different temperatures. As shown by the line of best fit through the data points, there is relatively little deviation from linear line over a range of glucose levels and temperature variations. Such data indicates that temperature does not generally affect the ratio of current-transients, and hence determination of analyte concentration.

### Correction Factor Determination

As outline above, a two-pulse signal can be applied to a fluid sample to determine an analyte concentration. The ratio of current-transients resulting from the two-pulse signal can be determined, and correlated with calibration data to determine analyte concentration. Such a determination can be more accurate than traditional techniques as the new method can be generally independent of hematocrit, temperature, and other blood constituents that can affect traditional electrochemical measurements. Another aspect of the present disclosure includes determination of a correction factor, wherein the correction factor may be applied to modify a measured steady-state current to provide a more precise and/or accurate measure of analyte concentration than offered using similar traditional techniques.

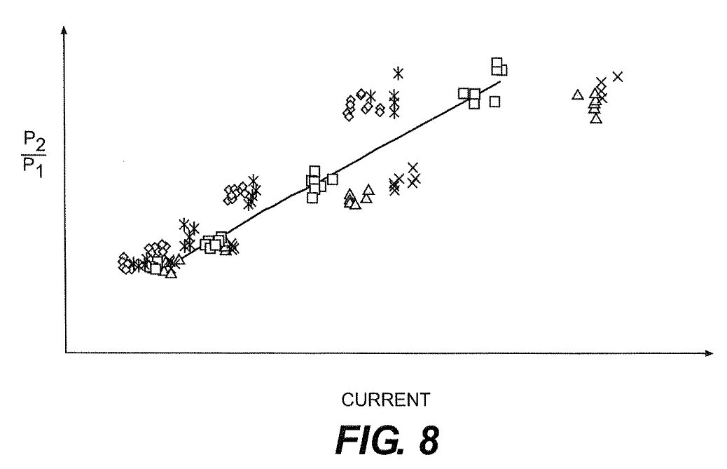

FIG. 8 is a graph depicting the relationship between a ratio of current-transients and steady-state current, according to an exemplary embodiment of the present disclosure. Steady-state current, such as a current value measure toward the end of second pulse 204 is generally proportional to analyte concentration, as previously described. This relationship generally holds for a relatively wide range of concentration values, however the technique can less accurate than the current-transient ratio method described herein. The present disclosure provides a method for determining a correction value that can be applied to a steady-state current to improve the accuracy of any resulting analyte concentration determination.

FIG. 8 depicts a line of best fit through a series of data corresponding to about 43% hematocrit measured at room temperature. This level of hematocrit is an expected value for average human blood samples, and most blood glucose measurements are taken at about room temperature. In addition, encoded calibration information can represent standardized data obtained from samples containing various concentrations of glucose measured at room temperature and with 43% hematocrit. Such data may be used to form a linear line of best fit (as shown in FIG. 8), wherein a mathematical equation can be derived to represent the list of best fit. For example, the line of best fit may be mathematically described by Equation No. 4:

y(x)=Ax+B

wherein y(x) represents a ratio of calculated currents, x represents a measured steady-state current, and A and B are variables determined by fitting data to the line. Other equations can also be used to represent the ratio of calculated currents, as described below.

As outlined above, a ratio of current-transients can be measured. In some embodiments, first pulse 202 at first potential 206 and second pulse 204 at second potential 208 can be applied to a sample solution containing an analyte. First potential 206 and second potential 208 can have the same polarity and second potential 208 can be larger than first potential 206, as previously described. Following, a ratio of current-transients associated with the two-pulse signal can be determined by sampling the current-transients at one or more common sampling times. This ratio can be termed a ratio of measured current-transients.

A second ratio termed a ratio of calculated current-transients may be determined using Equation No. 4, or other suitable equation representing a best fit of the current-transient ratio and the steady-state current data. The calculated current-transient ratio can be based on the steady-state current associated with second pulse 204. Specifically, the ratio of calculated current-transients can be determined by incorporating a value of measured steady-state current into the equation representing the data, such as Equation No. 4. In effect, this operation converts a steady-state current value into a corresponding current-transient ratio for a standard solution measured at room temperature with 43% hematocrit, as shown in FIG. 8. Specifically, data to the right of the line of best fit represent data obtained from samples of low hematocrit and/or high temperature, while data to the left of the line represent data obtained from samples of high hematocrit and/or low temperature. Mapping such data to the line of best fit for standardizes the data analysis such that calibration data obtained from standard solutions may be used in subsequent calculations.

The correction factor may be determined by dividing the ratio of measured current-transients by the ratio of calculated current-transients, as described by Equation No. 5:

$$Correction\_Factor = \frac{\frac{{P}_{2}}{{P}_{1}} ( measured )}{\frac{{P}_{2}}{{P}_{1}} ( calculated )}$$

This correction factor can be multiplied by the measured steady-state current to calculate a modified steady-state current. This modified current can then be used to determine analyte concentration as previously described, wherein the modified current is proportional to analyte concentration.

In some embodiments, the correction factor may be selectively applied to a determination of analyte concentration. For example, a correction factor may not be applied if the value of the correction is less than about +5%. In other embodiments, a correction factor may not be applied if the value is less than about ±10%. If the correction factor is greater than a suitable value, such as about 5% or 10%, then the correction factor can be applied to correct an analyte concentration. In some applications, the correction factor may include an upper limit, such as, for example, about ±30%. Correction factors outside this upper limit may not be applied in order to reduce the impact of erroneous correction.

In application, a correction factor could be applied to any suitable measurement. For example, a correction factor could be applied to a steady state current measurement, wherein an analyte concentration could be based on the corrected steady state current. In other embodiments, an uncorrected analyte concentration could be determined based on a steady state current measurement. Following, a correction factor could be applied to the uncorrected analyte concentration measurement to determine a corrected analyte concentration. Various other, or combined, applications of the correction factor described herein are contemplated by this disclosure.

### CONCLUSION

In summary, determining analyte concentration by determining a ratio of current-transients has a number of advantages. Such methods can be applied to various biosensors and/or meters, not just redox-based glucose sensors. The technique has a relatively high degree of accuracy as the affect of sample-dependent parameters, such as hematocrit, temperature, and other sample constituents, are reduced in equations of ratio form. Additionally, the correction factor method can further improve the accuracy of more traditional electrochemical techniques. Such a correction method can take advantage of a wide range of possible analyte concentration values using the steady-state current method and the accuracy of the current-transient ratio method. Analyte concentrations can be determined using either method or a combination of each method, depending upon the parameters associated with the analyte determination.

While various test strip structures and manufacturing methods are described as possible candidates for use to measure analyte concentration, they are not intended to be limiting of the claimed invention. Unless expressly noted, the particular test strip structures and meters are described merely as examples and are not intended to be limiting of the invention as claimed. It is also to be understood that the invention, while described in terms of determining an analyte concentration is applicable to quantifying a known concentration, for example when calibrating a meter to eliminate instrument error using a standard solution. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of determining an analyte concentration, comprising:
applying at least one first pulse at a first potential and at least one second pulse at a second potential to a sample solution containing an analyte, wherein the first potential and the second potential are the same polarity and the second potential is larger than the first potential;
measuring at least one first current-transient associated with the at least one first pulse and at least one second current-transient associated with the at least one second pulse;
determining a ratio between at least one said first current-transient and at least one said second current-transient, wherein said current-transients are measured at a substantially common sampling-time; and
determining an analyte concentration of the sample solution based on the ratio of said current-transients.

2. The method of claim 1, wherein the first potential is in a range of about 0.005 volts to about 0.5 volts, and the second potential is in a range of about 0.03 volts to about 3.00 volts.

3. The method of claim 2, wherein the first potential is about 0.05 volts and the second potential is about 0.30 volts.

4. The method of claim 1, wherein the at least one first pulse is applied for a first time-period and the at least one second pulse is applied for a second time-period not the same as the first time-period.

5. The method of claim 4, wherein the first time-period is in a range of about 0.02 seconds to about 2 seconds, and the second time-period is in a range of about 0.5 seconds to about 10 seconds.

6. The method of claim 5, wherein the first time-period is about 0.2 seconds and the second time-period is about 4 seconds.

7. The method of claim 1, wherein in the sampling-time is in the range of about 0.001 seconds to about 1 second.

8. The method of claim 7, wherein in the sampling-time is in the range of about 0.02 seconds to about 0.10 seconds.

9. The method of claim 1, wherein the sample solution includes a physiological fluid and the analyte includes glucose.

10. The method of claim 9, wherein the physiological fluid includes blood.

11. The method of claim 1, wherein at least one said first current-transient and at least one said second current-transient are at least partially generated by a redox reaction.

12. The method of claim 11, wherein the redox reaction is dependent upon a reagent selected from the group consisting of glucose oxidase, glucose dehydrogenase, potassium ferricyanide, and ruthenium hexamine.

13. The method of claim 1, wherein determining the analyte concentration further includes using calibration data.

14. The method of claim 1, further including determining the presence of a sufficient volume of the sample solution.

15. The method of claim 14, wherein the sufficient volume is less than about 1 micro-liter.

16. The method of claim 14, wherein determining the presence of the sufficient solution volume further includes measuring a resistance or impendence across a pair of fill-detect electrodes.

17. The method of claim 1, wherein applying the at least one first pulse and the at least one second pulse includes applying the at least one first pulse and the at least one second pulse across a pair of electrodes.

18. The method of claim 17, wherein measuring at least one said first current-transient and at least one said second current-transient includes measuring at least one said first current-transient and at least one said second current-transient across the pair of electrodes.

19. The method of claim 1, wherein determining the analyte concentration is further based on a steady-state current associated with the at least one second pulse.

20. A method of determining a correction factor, comprising:
applying at least one first pulse at a first potential and at least one second pulse at a second potential to a sample solution containing an analyte, wherein the first potential and the second potential are the same polarity and the second potential is larger than the first potential;
measuring at least one first current-transient associated with the at least one first pulse and at least one second current-transient associated with the at least one second pulse;
determining a first ratio of measured currents between at least one said first current-transient and at least one said second current-transient, wherein said current-transients are measured at a substantially common sampling-time;
determining a second ratio of calculated currents based on a steady-state current associated with the at least one second pulse; and
determining a correction factor based on the first and second ratios.

21. The method of claim 20, wherein the first potential is in a range of about 0.005 volts to about 0.5 volts, and the second potential is in a range of about 0.03 volts to about 3.00 volts.

22. The method of claim 21, wherein the first potential is about 0.05 volts and the second potential is about 0.30 volts.

23. The method of claim 20, wherein the at least one first pulse is applied for a first time-period and the at least one second pulse is applied for a second time-period not the same as the first time-period.

24. The method of claim 23, wherein the first time-period is in a range of about 0.02 seconds to about 2 seconds, and the second time-period is in a range of about 0.5 seconds to about 10 seconds.

25. The method of claim 24, wherein the first time-period is about 0.2 seconds and the second time-period is about 4 seconds.

26. The method of claim 20, wherein in the sampling-time is in the range of about 0.001 seconds to about 1 second.

27. The method of claim 26, wherein in the sampling-time is in the range of about 0.02 seconds to about 0.10 seconds.

28. The method of claim 20, wherein the sample solution includes a physiological fluid and the analyte includes glucose.

29. The method of claim 28, wherein the physiological fluid includes blood.

30. The method of claim 20, wherein at least one said first current-transient and at least one said second current-transient are at least partially generated by a redox reaction.

31. The method of claim 30, wherein the redox reaction is dependent upon a reagent selected from the group consisting of glucose oxidase, glucose dehydrogenase, potassium ferricyanide, and ruthenium hexamine.

32. The method of claim 20, wherein determining the correction factor further includes using calibration data.

33. The method of claim 20, further including determining the presence of a sufficient volume of the sample solution.

34. The method of claim 33, wherein the sufficient volume is less than about 1 micro-liter.

35. The method of claim 34, wherein determining the presence of the sufficient solution volume further includes measuring a resistance or impendence across a pair of fill-detect electrodes.

36. The method of claim 20, wherein applying the at least one first pulse and the at least one second pulse includes applying the at least one first pulse and the at least one second pulse across a pair of electrodes.

37. The method of claim 36, wherein measuring at least one said first current-transient and at least one said second current-transient includes measuring at least one said first current-transient and at least one said second current-transient across the pair of electrodes.

38. The method of claim 20, wherein the correction factor is used to modify the steady-state current.

39. The method of claim 38, wherein the modified steady-state current is used to determine the analyte concentration.

40. An analyte testing system, comprising:
a meter system configured to determine an analyte concentration of a sample solution, wherein the meter system is configured to:
apply at least one first pulse at a first potential and at least one second pulse at a second potential to a sample solution containing an analyte, wherein the first potential and the second potential are the same polarity and the second potential is larger than the first potential;
measure at least one first current-transient associated with the at least one first pulse and at least one second current-transient associated with the at least one second pulse;
determine a ratio between at least one said first current-transient and at least one said second current-transient, wherein said current-transients are measured at a substantially common sampling-time; and
determine the analyte concentration of the sample solution based on the ratio of said current-transients.

41. The system of claim 40, wherein the first potential is in a range of about 0.005 volts to about 0.5 volts, and the second potential is in a range of about 0.03 volts to about 3.00 volts.

42. The system of claim 41, wherein the first potential is about 0.05 volts and the second potential is about 0.30 volts.

43. The system of claim 40, wherein the at least one first pulse is applied for a first time-period and the at least one second pulse is applied for a second time-period not the same as the first time-period.

44. The system of claim 43, wherein the first time-period is in a range of about 0.02 seconds to about 2 seconds, and the second time-period is in a range of about 0.5 seconds to about 10 seconds.

45. The system of claim 44, wherein the first time-period is about 0.2 seconds and the second time-period is about 4 seconds.

46. The system of claim 40, wherein in the sampling-time is in the range of about 0.001 seconds to about 1 second.

47. The system of claim 46, wherein in the sampling-time is in the range of about 0.02 seconds to about 0.10 seconds.

48. The system of claim 40, wherein the sample solution includes a physiological fluid and the analyte includes glucose.

49. The system of claim 48, wherein the physiological fluid includes blood.

50. The system of claim 40, wherein at least one said first current-transient and at least one said second current-transient are at least partially generated by a redox reaction.

51. The system of claim 50, wherein the redox reaction is dependent upon a reagent selected from the group consisting of glucose oxidase, glucose dehydrogenase, potassium ferricyanide, and ruthenium hexamine.

52. The system of claim 40, wherein determining the analyte concentration further includes using calibration data.

53. The system of claim 52, wherein the calibration data is stored in a meter or a test strip.

54. The system of claim 40, further including determining the presence of a sufficient volume of the sample solution.

55. The system of claim 54, wherein the sufficient volume is less than about 1 micro-liter.

56. The system of claim 55, wherein determining the presence of the sufficient solution volume further includes measuring a resistance or impendence across a pair of fill-detect electrodes.

57. The system of claim 40, wherein applying the at least one first pulse and the at least one second pulse includes applying the at least one first pulse and the at least one second pulse across a pair of electrodes.

58. The system of claim 57, wherein measuring at least one said first current-transient and at least one said second current-transient includes measuring at least one said first current-transient and at least one said second current-transient across the pair of electrodes.

59. The system of claim 40, wherein determining the analyte concentration is further based on a steady-state current associated with the at least one second pulse.

60. An analyte testing system, comprising:
a meter system configured to determine an analyte concentration of a sample solution, wherein the meter system is configured to:
apply at least one first pulse at a first potential and at least one second pulse at a second potential to a sample solution containing an analyte, wherein the first potential and the second potential are the same polarity and the second potential is larger than the first potential;
measure at least one first current-transient associated with the at least one first pulse and at least one second current-transient associated with the at least one second pulse;
determine a first ratio of measured currents between at least one said first current-transient and at least one said second current-transient, wherein said current-transients are measured at a substantially common sampling-time;
determine a second ratio of calculated currents based on a steady-state current associated with the at least one second pulse;
determine a correction factor based on the first and second ratios; and
determine the analyte concentration of the sample solution based on the correction factor.

61. The system of claim 60, wherein the first potential is in a range of about 0.005 volts to about 0.5 volts, and the second potential is in a range of about 0.03 volts to about 3.00 volts.

62. The system of claim 61, wherein the first potential is about 0.05 volts and the second potential is about 0.30 volts.

63. The system of claim 60, wherein the at least one first pulse is applied for a first time-period and the at least one second pulse is applied for a second time-period not the same as the first time-period.

64. The system of claim 63, wherein the first time-period is in a range of about 0.02 seconds to about 2 seconds, and the second time-period is in a range of about 0.5 seconds to about 10 seconds.

65. The system of claim 64, wherein the first time-period is about 0.2 seconds and the second time-period is about 4 seconds.

66. The system of claim 60, wherein in the sampling-time is in the range of about 0.001 seconds to about 1 second.

67. The system of claim 66, wherein in the sampling-time is in the range of about 0.02 seconds to about 0.10 seconds.

68. The system of claim 60, wherein the sample solution includes a physiological fluid and the analyte includes glucose.

69. The system of claim 68, wherein the physiological fluid includes blood.

70. The system of claim 60, wherein at least one said first current-transient and at least one said second current-transient are at least partially generated by a redox reaction.

71. The system of claim 70, wherein the redox reaction is dependent upon a reagent selected from the group consisting of glucose oxidase, glucose dehydrogenase, potassium ferricyanide, and ruthenium hexamine.

72. The system of claim 60, wherein determining the analyte concentration further includes using calibration data.

73. The system of claim 62, wherein the calibration data is stored in a meter or a test strip.

74. The system of claim 60, further including determining the presence of a sufficient volume of the sample solution.

75. The system of claim 74, wherein the sufficient volume is less than about 1 micro-liter.

76. The system of claim 75, wherein determining the presence of the sufficient solution volume further includes measuring a resistance or impendence across a pair of fill-detect electrodes.

77. The system of claim 60, wherein applying the at least one first pulse and the at least one second pulse includes applying the at least one first pulse and the at least one second pulse across a pair of electrodes.

78. The system of claim 77, wherein measuring at least one said first current-transient and at least one said second current-transient includes measuring at least one said first current-transient and at least one said second current-transient across the pair of electrodes.

79. The system of claim 60, wherein the correction factor is used to modify the steady-state current.

80. The system of claim 79, wherein the modified steady-state current is used to determine the analyte concentration.

81. A calibration method, comprising;
applying a standard solution to a first test strip;
applying at least one first pulse at a first potential and at least one second pulse at a second potential to the standard solution, wherein the first potential and the second potential are the same polarity and the second potential is larger than the first potential;
measuring at least one first current-transient associated with the at least one first pulse and at least one second current-transient associated with the at least one second pulse;
determining a ratio between at least one said first current-transient and at least one said second current-transient, wherein said current-transients are measured at a substantially common sampling-time; and
determining calibration data based at least in part on the ratio of said current-transients.

82. The method of claim 81, wherein the standard solution contains an analyte of known concentration and the calibration data includes data representative of the analyte concentration.

83. The method of claim 81, further including displaying the calibration data to a user.

84. The method of claim 83, wherein the calibration data is displayed to the user by a meter configured to receive the first test strip.

85. The method of claim 81, wherein the calibration data is determined as part of a manufacturing process.

86. The method of claim 85, further including manufacturing a second test strip associated with the manufacture of the first test strip.

87. The method of claim 86, wherein the manufacturing process further includes encoding the calibration data on the second test strip.

88. A calibration method, comprising;
applying a standard solution to a first test strip;
applying at least one first pulse at a first potential and at least one second pulse at a second potential to the standard solution, wherein the first potential and the second potential are the same polarity and the second potential is larger than the first potential;
measuring at least one first current-transient associated with the at least one first pulse and at least one second current-transient associated with the at least one second pulse;
determining a first ratio between at least one said first current-transient and at least one said second current-transient, wherein said current-transients are measured at a substantially common sampling-time;
determining a second ratio of calculated currents based on a steady-state current associated with the at least one second pulse; and
determining calibration data based at least in part on the first and second ratios.

89. The method of claim 88, wherein the standard solution contains an analyte of known concentration and the calibration data includes data representative of the analyte concentration.

90. The method of claim 88, further including displaying the calibration data to a user.

91. The method of claim 90, wherein the calibration data is displayed to the user by a meter configured to receive the first test strip.

92. The method of claim 88, wherein the calibration data is determined as part of a manufacturing process.

93. The method of claim 92, further including manufacturing a second test strip associated with the manufacture of the first test strip.

94. The method of claim 93, wherein the manufacturing process further includes encoding the calibration data on the second test strip.
